(19) United States
(12) Patent Application Publication
(10) Pub. No.: US 2010/0300962 A1
(43) Pub. Date: Dec. 2, 2010

(54) METHODS FOR TREATING WASTEWATER USING AN ORGANIC COAGULANT

(75) Inventor: Reed Semenza, Galt, CA (US)

Correspondence Address: Hovey Williams LLP, 10801 Mastin Blvd., Suite 1000, Overland Park, KS, 66210, US

(73) Assignee: DELAVAL HOLDING AB, Tumba (SE)

(21) Appl. No.: 12/791,652

(22) Filed: Jun. 1, 2010

Related U.S. Application Data
(60) Provisional application No. 61/183,544, filed on Jun. 2, 2009.

(51) Int. Cl. C02F 1/54; C02F 3/32

(52) U.S. Cl. 210/602; 210/728; 210/207; 210/170.09

(57) ABSTRACT

A wastewater treatment system is disclosed which uses algae to generate oxygen for primary digestion of municipal wastewater. A coagulant composition containing a cationic starch and an aluminum salt is used to remove algae and other solids from the wastewater stream. The unique combination of the starch coagulant and algae species produced water of exceptionally low turbidity.

### RELATED APPLICATION

The present application claims the benefit of U.S. Provisional Patent Application No. 61/183,544, entitled “Methods for Treating Waste Water Using an Organic Coagulant,” filed Jun. 2, 2009. The foregoing application is hereby incorporated by reference in its entirety.

### BACKGROUND

1. Field of the Invention

The present invention pertains to compositions and methods for treating wastewater. More particularly, it relates to the treatment of wastewater containing algae and the removal of said algae from the wastewater.

2. Description of the Related Art

Algae have long been reported as an effective wastewater treatment agent. See, e.g., U.S. Pat. No. 3,882,635. However, broad application of algae in wastewater treatment facility has been hindered by the practical difficulties in removing the algae from the purified water. Many state and local governments have imposed strict regulations with respect to the amount of particulate matter (or solids) that is allowed in the liquid released from a wastewater treatment facility. Because of their small size, algae are particularly difficult to remove from the wastewater stream.

For instance, an integrated system termed Advanced Integrated Waste Water Pond System (“AIWPS”) has been reported (Energy Efficient WW Treatment at Hilmar C A; Green, Lundquist, Brown, 2006), which includes a series of ponds designed to maximize the removal of organic materials from the wastewater. In this system, algae are added to a wastewater system to generate oxygen which, in turn, may be used for primary digestion of the wastewater by bacteria. Although the AIWPS system is effective at digesting BOD and reducing electrical costs associated with aeration, this system alone does not always meet the governmental regulations imposing a limit on the amount of total suspended solids (TSS) in water that is being released from a water treatment facility. For instance, the State of California sets a Discharge Limit (CSDL) at 40 ppm TSS.

Sedimentation and coagulation accomplished by the addition of suitable coagulants have been used to remove solids from wastewater. However, many coagulants contain metals that have undesirable effects such as increased salt loading and sludge production. The disposal of the removed solids concentrated with aluminum or iron metals presents a significant problem. Screening or filtration methods have also been attempted; however, most filtration methods are not practical due to the small size of the algae. Other mechanical methods using separators such as nozzle and plate separators have also been used, but they require considerable amount of energy consumption.

### SUMMARY

The present disclosure provides a composition capable of removing the majority of solids, such as algae, from wastewater. The composition may be used in a variety of settings, which may include but are not limited to municipal water treatment systems, food processing wastewater treatment systems, and dairy or animal farm wastewater treatment systems.

According to the present disclosure, a composition comprising cationic starch polymer and at least one aluminum salt may be added in the waste process stream just prior to, or further upstream of the algae settling ponds (ASPs) to help coagulate particulate matters (solids), such as algae. In one aspect, the aluminum salt may be a polyaluminum chloride having the general formula AlₙCl₍₃ₙ₋ₘ₎(OH)_{m,} wherein n is an integer ranging from 1 to 20, and m is an integer ranging from 1 to 20. Preferably, the polyaluminum chloride is aluminum chlorohydrate (ACH or Al₂Cl(OH)₅). Other polyaluminum chloride may also be used in place of ACH. In one preferred embodiment of this disclosure, WWT 6100S manufactured and distributed by DeLaval (Kansas City, Mo.) may be used as a coagulant. WWT 6100S is a 1:1 (w/w) mixture of cationic starch polymer (WWT 5162 from Dober Group (Woodridge, Ill.) which contains 40% active ingredient, and a form of aluminum chlorohydrate which contains 50% active ingredient. Aluminum chlorohydrate is also known as ACH, or Al₂Cl(OH)₅.

Cationic starches may be obtained from natural or synthetic sources, for example, from potato starch, waxy maize starch, corn starch, wheat starch, or rice starch. Exemplary cationic starches may be substituted to a certain degree of substitution that may be determined based upon specific circumstances. A relatively high degree of substitution (D.S.) may include values greater than about 0.03. Suitable substituents include but are not limited to tertiary and quaternary amine groups. Generally, cationic starch may be prepared by reacting starch with a reagent containing a quaternary nitrogen, yielding a positive charge that is independent of pH. Reagents used are typically reactive quaternary compounds such as 3-Chloro-2-hydroxypropyltrimethyl ammonium chloride. The reagent usually attaches to the starch at the C6 position, the most accessible of the —OH groups. In certain embodiments, the level of derivatization is one to two charged groups per hundred glucose units. Examples of cationic starch include but are not limited to tertiary aminoalkyl starch ethers and quaternary ammonium starch ethers, etc. Other examples of suitable cationic starch include those disclosed in U.S. Pat. Nos. 5,071,512 and 5,543,056, which arc incorporated herein by reference.

In one embodiment, one type of hydrophobic formation cationic starch (PSOAMDA) may be prepared from starch (St), octadecyl acrylate (OA), acrylamide (AM) and dimethyl dialkyl ammonium chloride (DMDAAC). In another embodiment, the cationic starch may be prepared by means of an inverse suspension polymerization reaction with a redox initiator where the molar ratio of St:AM: DMDAAC: OA may be set at approximately 4:8:1.5:0.6 and the reaction temperature may be set at 40 C. with the duration of reaction set at about 3 h.

In another aspect, a coagulant composition may comprise a cationic starch and a polyaluminum chloride having the general formula of AlₙCl₍₃ₙ₋ₘ₎(OH)ₘ, wherein n is an integer ranging from 1 to 20, m is an integer ranging from 1 to 20, and the cationic starch and the polyaluminum chloride may be present at an amount effective in removing at least 85% of solids from a liquid suspension when the composition is added to the liquid suspension containing solids. Preferably, the cationic starch and the polyaluminum chloride are present at an amount effective in removing at least 90%, or more preferably 95%, of solids from a liquid suspension when the composition is added to the suspension containing solids.

In another aspect, the ratio by weight between the cationic starch and the polyaluminum chloride may be between 0.2 (i.e., 1:0.2) and 5 (i.e., 1:5). More preferably, the cationic starch and the polyaluminum chloride are present in the composition at a weight ratio of about 1, i.e., 1:1 (w/w). The cationic starch and the aluminum salt may be added into the wastewater stream separately, or they may be pre-mixed and added to the wastewater stream together.

For purpose of this disclosure, the concentration of the coagulant composition refers to the respective concentration of each active ingredient. The amount of the coagulant composition that is effective in removing solids from the liquid suspension may be as low as 1 ppm each of cationic starch and aluminum salt in the liquid suspension. Although increasing the amount of the composition usually increases precipitation of solids from the suspension, the working concentration of the disclosed coagulant is generally 1-500 ppm. In other words, when the effective amount of the composition is added to the liquid suspension, the cationic starch and the polyaluminum chloride are each present in the liquid suspension at a concentration in the range of from about 1 ppm to about 500 ppm. In a preferred embodiment, the respective concentration of the cationic starch and the aluminum salt in the coagulant composition is from about 3 ppm to about 80 ppm, preferably from about 6 ppm to about 40 ppm, or even more preferably, from about 10 ppm to about 20 ppm.

In another aspect, at least one species of algae may be added into the wastewater processing system before the coagulant composition is added. The algae not only consume excess nutrients in the wastewater, but they may also help supersaturate the surrounding water with oxygen. Some of the oxygenated water may be re-circulated to the primary aerobic digestion pond (“High Rate Pond” or “HRP”) in order to provide oxygen for the bacteria. The rest of the oxygenated water may be sent to algae settling ponds (“ASP”) where the algae are allowed to settle out.

The coagulant composition containing cationic starch and ACH may be injected into the waste process stream just prior to, or further upstream of the ASPs. The mixture containing the coagulant composition and the liquid suspension may then be mixed for 1-2 minutes. The resulting mixture may then be incubated or allowed to react and settle in the ASPs for a period of from 1 minute to 2 days, more preferably from 30 minutes to one day. In a preferred embodiment, the composition is allowed to be incubated with said liquid suspension for a period of from 1 minute to 20 minutes.

The unique combination of the cationic starch, ACH and algae produces water of exceptionally low turbidity. For instance, when such a composition is added to a liquid suspension with turbidity of at least 40 nephelometric turbidity units (NTU), it may help remove at least 85%, 90%, or ever more preferably, 95% of the solids in the suspension and reduce the turbidity of the suspension to as low as 2 NTU. This result is surprising because conventional aluminum or iron based coagulants either are ineffective or introduce to the final effluent a relatively high quantity of dissolved ions such as chloride or sulfate. In another aspect, the coagulant composition may be added a liquid suspension and reduce the turbidity of the suspension by at least 85%, more preferably 90%.

In another embodiment according to the present invention, there is provided a wastewater treatment system comprising a reservoir containing a volume of wastewater having an amount of solids suspended therein. The suspended solids comprise, at least in part, one or more species of algae. Other organic, particulate matter also may be suspended in the wastewater. The wastewater also comprises a quantity of a coagulant composition as described herein. The reservoir is configured to hold the wastewater for a sufficient period of time to permit coagulation and settling of at least a portion of the algae suspended therein.

### BRIEF DESCRIPTION OF THE DRAWINGS

FIG. 1 shows the effect of the disclosed coagulant composition in reducing the turbidity of the wastewater stream when added just prior to the ASPs (Speed in the legend refers to Pump speed).

FIG. 2 schematically illustrates an exemplary wastewater handling system and depicts exemplary locations where the disclosed coagulant composition may be introduced.

### DETAILED DESCRIPTION

There will now be shown and described compositions and methods that can be used to effectively remove solids such as algae from wastewater stream. A composition containing a cationic starch, a salt such as aluminum chlorohydrate is effective in removing algae or other solids from the wastewater stream in a wastewater processing facility. Besides cationic starch, other polysaccharides capable of binding and coagulating particulate matter, such as algae, may be used.

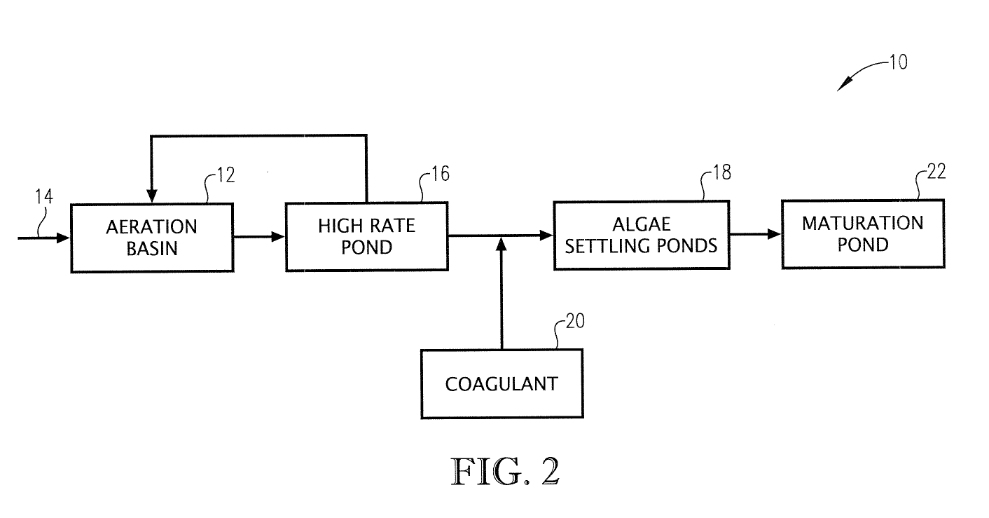

In order to minimize electricity usage, some water treatment plants utilize algae to generate oxygen for primary digestion of wastewater. One such system, termed the Advanced Integrated Waste Water Pond System (AIWPS), comprises a series of ponds designed to maximize the growth of algae. Note, as used herein, the term “ponds” is intended to refer not only to open, in-ground reservoirs, but also to other types of vessels such as above or below grade, open or closed tanks. Likewise, each of the various ponds or reservoirs may comprise plural units installed in parallel to permit filling of one while another drains. In a typical AIWPS system, the algae not only consume excess nutrients, but also supersaturate the surrounding water with oxygen. FIG. 2 schematically illustrates one type of AIWPS system 10. It should be noted, however, that the present invention is not limited to AIWPS systems and may be utilized in other types of wastewater treatment systems and processes that employ algae.

Generally, system 10 comprises an aeration basin (“AB”) 12 which receives a stream of wastewater 14. In one embodiment, AB 12 contains electric aerators to provide oxygen for primary digestion of waste materials present in the wastewater stream. The wastewater is then directed to a primary aerobic digestion pond 16 or a high-rate pond (“HRP”) where algae naturally grow and provide oxygen for bacteria present in the HRP. After the wastewater is detained in HRP 16 for a sufficient amount of time, a portion of the oxygenated wastewater is recycled to AB 12 to enhance oxygen levels for primary digestion and the remainder is directed to one or more algae settling ponds (“ASPs”) 18 where algae are settled from the wastewater. Prior to delivery to ASPs 18, a coagulant composition 20 according to the present invention may be injected into the wastewater stream. Alternatively, coagulant 20 may be introduced directly into ASP 18. Effluent from the ASPs may be sent to a “finishing” pond or Maturation Pond (“MP”) 22 for final equalization and nutrient removal. Occasionally, and in certain embodiments once a month, the ASPs are drained so that the settled algae can be returned to the HRP 16. Alternatively, the settled algae may be sent to an algae drying bed and allowed to be dried before being land applied. Once in a while, when significant amount has accumulated in the system, the algae may be removed in order to prevent the buildup of non-digestible solids in the AIWPS system.

Typically, the water entering the ASP contains algae and has turbidity of 20 NTU or higher. Although the AIWPS described above is very effective at digesting BOD and reducing electrical costs associated with aeration, much of the algae remained suspended in the ASP effluent and finishing ponds resulting in a total suspended solids (TSS) level that is higher than the TSS standards set by some states, such as the California State Discharge Limit (CSDL) of 40 ppm TSS. To facilitate removal of algae from the water stream, a coagulant containing cationic starch may be injected into the waste process stream just prior to the ASPs. One example of such a starch-containing coagulant is DeLaval WWT 6100S, which is a 1:1 (w/w) mix of cationic starch polymer and aluminum chlorohydrate. The unique combination of this coagulant and algae species generates water of exceptionally low turbidity. In some cases, the turbidity of the processed water can reach 10 NTU, or as low as 5 NTU, or even lower.

In addition to reducing the turbidity of the wastewater stream, the compositions disclosed herein also have certain advantages that are desirable in wastewater treatment programs. First, the combination of algae and bacteria is carbon neutral. Because the algae consume CO₂ that the bacteria liberate, and because the algae produce oxygen without the use of electricity, the overall program is carbon neutral.

Secondly, the combination of algae and starch-containing coagulants helps reduce the generation of sludge. Unlike inorganic coagulants, the coagulants disclosed herein produce very little additional non-biodegradable solids resulting in reduced algae solids handling and disposal cost. Moreover, the starch coagulant, such as WWT 6100S, adds minimal total dissolved solids (TDS) to the final effluent and is itself mostly bio-degradable.

Third, the coagulants of the present disclosure are typically nearly pH neutral and also present very low levels of toxicity to humans and other animals. Also, the product can be fed neat without any need to dilute with water and no need to be added in conjunction with a flocculent or pH adjustment.

In one aspect, a composition containing cationic starch and ACH may be injected into a below grade mixing tank which supplies both mixing energy and detention time. Detention time is required to allow for the coagulation process to reach completion, which usually takes about 1 to 60 minutes, preferably about 1-10 minutes, and most preferably about 5 minutes. The treated water then enters the front of the algae setting ponds where the algae are allowed to settle out. Each ASP has a detention time ranging from 24-48 hours, more preferably about 36 hours. Water flows through the ASP to the back of the pond where the water flows through a tube settler then over a weir.

The dosage of the composition containing cationic starch and ACH to be added may vary depending upon the amount of solids in the water stream. Preferably, the respective concentration of the cationic starch and the aluminum salt such as ACH is in the range from about 1 ppm to about 500 ppm. In a preferred embodiment, the respective concentration of the cationic starch and the aluminum salt in the coagulant composition is from about 3 ppm to about 80 ppm, preferably from about 6 ppm to about 40 ppm, or even more preferably, from about 10 ppm to about 20 ppm. In order to achieve a higher level of algae removal, WWT 6100S is preferably added as far upstream to the algae settling ponds as possible. Anionic flocculants are not required, but may be included if desired.

The WWT 6100S is a starch-based polymer that is advantageous over polymers when used as a coagulant. In one preferred embodiment, this 1:1 mixture of cationic starch and ACH is capable of removing 90%, or even 95% or more of TSS at a dose of 60-80 ppm within a contact time of only 5 minutes. Secondly, unlike inorganic or synthetic polymers, starch polymers add minimal soluble or insoluble solids to the water. Third, starch polymers are non-toxic, and typically do not consume alkalinity, and do not add significant salt to the effluent. Fourth, because the algae can produce oxygen, the biochemical oxygen demand (BOD) impact is minimal. Lastly, starch polymers are safe to handle, and may be fed neat. The starch polymer also are non-corrosive, and have a wide application window. Also, overfeed of the starch based compositions will not interfere with coagulation.

The total time required to settle the algae is typically 30 to 60 minutes, but the settling may last longer if desired. In general, the longer the algae are allowed to settle after treatment with the disclosed composition, the higher percentage of the solids are separated from the rest of the suspension. Flocculants may be added but they are not required. The algae removal may reach as high as 90% or greater based on turbidity measured in NTUs (nephelometric turbidity units).

The term “coagulant composition” and “composition” may be used interchangeably in this disclosure, both referring to the new and improved composition capable of removing at least 85% solids from a liquid suspension when added to said suspension in an effective amount. In a preferred embodiment, the “coagulant composition” or “composition” is capable of removing at least 90%, or even 95% solids from a liquid suspension when added to said suspension in an effective amount.

The term “ppm” is used to specify the amount of an ingredient in the liquid suspension, such as a wastewater stream. Thus, 1 ppm means that 1 gram of pure ingredient is present in 1000 kg of a solution or a liquid suspension. In practice, when the material added is not pure, i.e., the material contains less than 100% active ingredient, the final concentration in “ppm” is calculated based on the percentage of pure/active ingredient present in the total material added. For purpose of this disclosure, when 1 gram each of pure cationic starch and pure ACH are added to 1000 kg of a solution or suspension, it can be said that the composition is present in the suspension at 1 ppm each of cationic starch and ACH, or that the cationic starch and ACH are each present at 1 ppm in the liquid suspension.

### EXAMPLES

### Example 1

### Comparison of the Ability of Different Polymers to Remove Algae

In order to evaluate various polymers that may be used to remove algae from a water treatment plant, tests were performed in a wastewater treatment plant (Plant A) which treats about 650,000 gpd (gallon per day) during dry weather and up to 850,000 gpd during wet weather. In Plant A, influent first enters an aerated primary treatment pond. The treated water then enters a secondary algae pond. The algae pond supernatant is pumped back to the primary pond to deliver oxygen. About half of the water is returned. The rest of the water is treated via settling ponds to remove algae and then discharged to a percolation bed.

One major problem for Plant A was that algae naturally grow in the secondary treatment pond contributing to suspended solids in the plant effluent and interfering with the TSS (total suspended solids) removal process. Various filtration methods had been tested to help eliminate the algae. However, initial tests indicated that filters alone failed to effectively remove the algae due to the small size of the algae and the high cost of filters.

A number of different polymers were tested to determine their ability to precipitate or coagulate suspended algae from the water. Each one liter sample of secondary pond effluent was treated with various polymers, mixed and then aged for 5 minutes. A summary of the test results are shown in Table 1.

TABLE 1
Test Results of Different Polymers' Ability to Remove Algae

| Polymer | | | | |
|---|---|---|---|---|
| and range | base | best dose* | water clarity | floc size |
| WWT 6100S | starch | 60 (50-300) | excellent | excellent |
| WWT CS 40 | DMDAAC | 80 (70-90) | good | good |
| C40G | PAM | 40 (30-60) | good | fair |
| Klaraid 10 | ACH | 100 (100-150) | good | fair |

*Best dose is the weight in grams of the polymer used per 1000 kg of water.

Water clarity was determined by sight, i.e., by how clearly the numbers on the beaker can be seen when an examiner is looking through the beaker. Floc (flocculants) size was a relative term and acceptable floc settled in about 5 minutes.

WWT 6100S is a 1:1 (w/w) mixture of cationic starch polymer and aluminum chlorohydrate (ACH). WWT CS 40 is a DMDAAC based polymer. C40G (manufactured by Ashland) is a PAM (polyacrylamide) based polymer. Klaraid 10 manufactured by DeLaval is an ACH/DMDAAC blend. The starch based polymer WWT 61005 produced the best results. When the C40G or the WWT A40 (or WWT CS 40) was tested as an adjunct to the WWT 6100S coagulants, the floc size was increased significantly with the addition of just 1 gram of the C40G or the WWT A40 per 1000 kg of wastewater. However, given the settling time in the ASP, the anionic polymer is not required.

### Example 2

### Determination of Optimal Dosage of the Starch-based Coagulants

In order to determine the optimal coagulant dosage, a Jar Test was performed. A series of jars were set up each holding the same amount of water taken from water stream upstream of the ASPs in Plant A. The jar test was performed by mixing the 6100S into the jars and mixing at high speed for one minute. The jars were then allowed to settle for 5 minutes before being evaluated. Note that more improvement would be expected with more settling time. Therefore, dosage lower than the recommended dose may be used if longer settling time can be afforded.

The jar tests indicated that the economically optimum coagulant (WWT6100S) dose is 75 grams (plus or minus 10 grams) total WWT6100S per 1000 kg wastewater. At 50 grams total WWT6100S per 1000 kg wastewater, the 6100S produced water of good quality but some haze was evident. When used at 75 grams total WWT6100S per 1000 kg wastewater, the 6100S produced water that is very clear with well formed floc. At 100 grams total WWT6100S per 1000 kg wastewater, the resultant water was only slightly clearer than that produced when 75 grams were used, and the floc particles are also larger at 100 grams as compared to the floc size when 75 grams per 1000 kg wastewater were used. The working concentrations of the coagulant composition in Beakers 1-4 are summarized in Table 2.

TABLE 2
Jar Test using different dosage of WWT6100S

| | | conc. of | conc. of | |
|---|---|---|---|---|
| Test # | Dose | Starch (ppm) | ACH (ppm) | Water clarity |
| 1 | 50 | 10 | 12.5 | good |
| 2 | 75 | 15 | 18.75 | excellent |
| 3 | 100 | 20 | 25 | excellent |
| 4 | 125 | 25 | 31.25 | excellent |

Various composition containing different ratio of the cationic starch (with 40% active ingredient) and ACH (with 50% active ingredient) were tested using Jar Test for their capability to remove algae from wastewater. The results of these tests are summarized in Table 3.

TABLE 3
Jar Test using various coagulant composition with
different ratio of cationic starch and ACH

| | | | | | | conc. of | conc. of |
|---|---|---|---|---|---|---|---|
| | % Starch | % ACH | | | Dose* | Starch | ACH |
| Test# | (40% active) | (50% active) | Water clarity | Floc size | (gram) | (ppm) | (ppm) |
| 1 | 50 | 50 | excellent | large | 60 | 12 | 15 |
| 2 | 30 | 70 | excellent | medium | 80 | 9.6 | 28 |
| 3 | 70 | 30 | excellent | large | 90 | 25.2 | 13.5 |
| 4 | 90 | 10 | good | large | 150 | 54 | 7.5 |
| 5 | 10 | 90 | excellent | medium | 120 | 6 | 54 |

*dose is the weight in grams of the total composition used per 1000 kg of water treated

### Example 3

### Field Trial

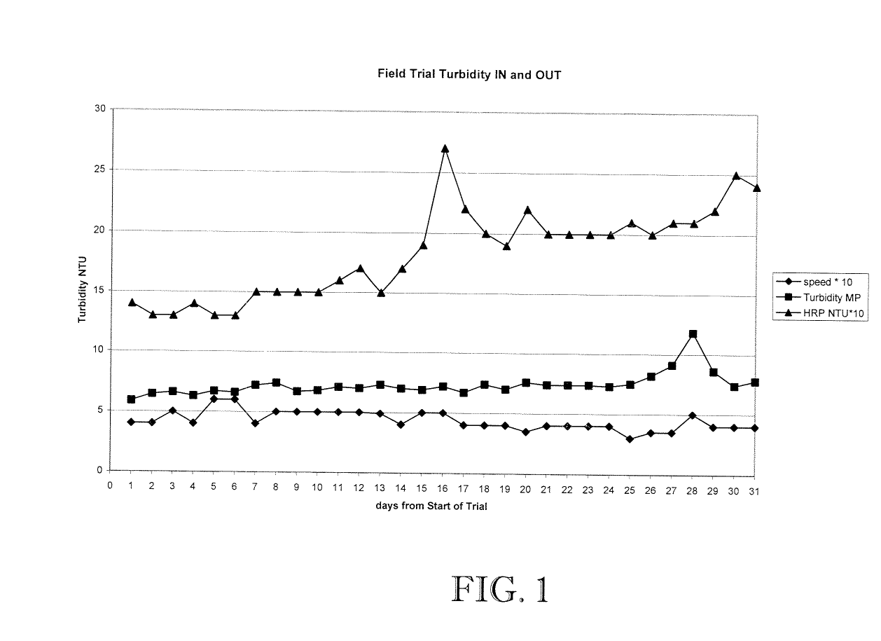

A field trail was conducted in which WWT 6100S was injected into a mixing chamber just before the wastewater enters the ASP. The WWT 6100S was injected continuously at a dose of 60 grams of total WWT 6100S per 1000 kg of wastewater. Samples of ASP influent and maturation pond (MP) effluent were taken every morning for one month. The samples were tested for turbidity on a Hach electronic turbidity meter and measured in nephelometric turbidity units (NTU) which is the standard for regulatory purposes. Comparison of the ASP influent and MP effluent show an average reduction in NTU of 95% or greater. The samples for ASP influent were taken from the HRP effluent and therefore are indicated as HRP NTU in FIG. 1 and Table 4.

TABLE 4
Field Trial Data showing Reduction of Turbidity by the Coagulant

| Days | dose | | | | |
|---|---|---|---|---|---|
| after | (pump | speed * | Turbidity | HRP | % NTU |
| Start | speed) | 10 | MP | NTU* 10 | reduction |
| 1 | 40 | 4 | 5.9 | 14 | 96 |
| 2 | 40 | 4 | 6.45 | 13 | 95 |
| 3 | 50 | 5 | 6.6 | 13 | 95 |
| 4 | 40 | 4 | 6.3 | 14 | 96 |
| 5 | 60 | 6 | 6.7 | 13 | 95 |
| 6 | 60 | 6 | 6.6 | 13 | 95 |
| 7 | 40 | 4 | 7.2 | 15 | 95 |
| 8 | 50 | 5 | 7.4 | 15 | 95 |
| 9 | 50 | 5 | 6.7 | 15 | 96 |
| 10 | 50 | 5 | 6.8 | 15 | 95 |
| 11 | 50 | 5 | 7.1 | 16 | 96 |
| 12 | 50 | 5 | 7 | 17 | 96 |
| 13 | 49 | 4.9 | 7.3 | 15 | 95 |
| 14 | 40 | 4 | 7 | 17 | 96 |
| 15 | 50 | 5 | 6.9 | 19 | 96 |
| 16 | 50 | 5 | 7.2 | 27 | 97 |
| 17 | 40 | 4 | 6.7 | 22 | 97 |
| 18 | 40 | 4 | 7.4 | 20 | 96 |
| 19 | 40 | 4 | 7 | 19 | 96 |
| 20 | 35 | 3.5 | 7.6 | 22 | 97 |
| 21 | 40 | 4 | 7.4 | 20 | 96 |
| 22 | 40 | 4 | 7.4 | 20 | 96 |
| 23 | 40 | 4 | 7.4 | 20 | 96 |
| 24 | 40 | 4 | 7.3 | 20 | 96 |
| 25 | 30 | 3 | 7.5 | 21 | 96 |
| 26 | 35 | 3.5 | 8.2 | 20 | 96 |
| 27 | 35 | 3.5 | 9.1 | 21 | 96 |
| 28 | 50 | 5 | 11.8 | 21 | 94 |
| 29 | 40 | 4 | 8.6 | 22 | 96 |
| 30 | 40 | 4 | 7.4 | 25 | 97 |
| 31 | 40 | 4 | 7.8 | 24 | 97 |

Note that the turbidity of the ASP influent NTUs has been divided by 10 before plotting so that the NTU trends can be better compared on the same graph. Pump speed has also been divided by 10, as indicated by “Speed*10.”

Those skilled in the art will appreciate that the foregoing discussion teaches by way of example, and not by limitation. Insubstantial changes may be imposed upon the specific embodiments described here without departing from the scope and spirit of the invention.

What is claimed is:

1. A method for removing solids from a liquid suspension, comprising the step of adding to said liquid suspension an effective amount of a composition comprising a cationic starch and an aluminum salt.

2. The method of claim 1, wherein said aluminum salt has the formula AlₙCl₍₃ₙ₋ₘ₎(OH)ₘ, wherein n is an integer ranging from 1 to 20, and m is an integer ranging from 1 to 20.

3. The method of claim 2, wherein the aluminum salt is Al₂Cl(OH)₅.

4. The method of claim 1, wherein said effective amount is the respective amounts of said cationic starch and said aluminum salt capable of removing at least 85% of the solids from said liquid suspension when said respective amounts of the cationic starch and the aluminum salt are added to the liquid suspension.

5. The method of claim 1, wherein the ratio by weight between said cationic starch and said aluminum salt is between 1:0.2 to 1:5.

6. The method of claim 1, wherein the ratio by weight between said cationic starch and said aluminum salt is about 1.

7. The method of claim 1, wherein said cationic starch and said aluminum salt are each present in said liquid suspension at 1-500 ppm when said effective amount of the composition is added to said liquid suspension.

8. The method of claim 1, wherein said cationic starch and said aluminum salt are each present in said liquid suspension at 3-80 ppm when said effective amount of the composition is added to said liquid suspension.

9. The method of claim 1, wherein said liquid suspension is from a wastewater treatment system selected from the group consisting of municipal water treatment system, food processing wastewater treatment system, dairy farm wastewater treatment system, and animal farm wastewater treatment system.

10. The method of claim 1, wherein said solids comprise algae.

11. The method of claim 1 further comprising the step of adding at least one species of algae into said liquid suspension prior to the step of adding said effective amount of said composition into said liquid suspension.

12. The method of claim 1 further comprising the step of allowing said composition to be incubated with said liquid suspension for a period of from 1 minute to 20 minutes.

13. The method of claim 1 further comprising the step of allowing said composition to coagulate the solids in said liquid suspension and thereby reduce the turbidity of said liquid suspension by at least 85%.

14. The method of claim 11, wherein said liquid suspension has a turbidity of at least 20 NTU before addition of said composition.

15. The method of claim 14, wherein said liquid suspension has a turbidity of less than about 10 NTU after the addition of said composition to said liquid suspension.

16. A method for removing algae from a wastewater treatment system comprising the steps of:
(a) providing a supply of wastewater containing at least one species of algae; and
(b) adding to said algae-containing wastewater a quantity of a composition comprising a cationic starch and an aluminum salt having the formula AlₙCl₍₃ₙ₋ₘ₎(OH)ₘ, wherein n is an integer ranging from 1 to 20, m is an integer ranging from 1-20, said composition causing at least a portion of said algae in said wastewater to coagulate and settle out of said wastewater.

17. The method of claim 16, wherein said cationic starch and aluminum salt are added to said algae-containing wastewater at a level of 1-500 ppm each.

18. The method of claim 16, wherein said supply of wastewater has a turbidity of at least 20 NTU prior to step (b).

19. The method of claim 18, wherein supply of wastewater has a turbidity of less than about 10 NTU after step (b).

20. The method of claim 16, wherein step (a) comprises adding at least one species of algae to said wastewater.

21. A wastewater treatment system comprising a reservoir containing a volume of wastewater, said wastewater having an amount of solids suspended therein, and wherein at least a portion of said suspended solids comprise one or more species of algae, said wastewater contained within said reservoir comprising a quantity of a coagulant composition, said coagulant composition comprising a cationic starch and an aluminum salt, said reservoir configured to hold said wastewater for a sufficient period of time to permit coagulation and settling of at least a portion of the algae suspended in said wastewater.

22. The wastewater treatment system according to claim 21, wherein said reservoir comprises an algae settling pond.

23. The wastewater treatment system according to claim 22, wherein said wastewater treatment system further comprises a high-rate pond located upstream from said algae settling pond.

24. The wastewater treatment system according to claim 22, wherein said wastewater treatment system further comprises a maturation pond located downstream from said algae settling pond.

25. The wastewater treatment system according to claim 21, wherein said aluminum salt has the formula AlₙCl₍₃ₙ₋ₘ₎(OH)ₘ, wherein n is an integer ranging from 1 to 20, m is an integer ranging from 1-20.

26. The wastewater treatment system according to claim 25, wherein said cationic starch and aluminum salt are present in said reservoir wastewater at a level of 1-500 ppm each.
